(19) United States
(12) Patent Application Publication
(10) Pub. No.: US 2021/0223717 A1
(43) Pub. Date: Jul. 22, 2021

(54) DEVELOPING DEVICE

(71) Applicant: CANON KABUSHIKI KAISHA, Tokyo (JP)

(72) Inventor: Takashi Ninomiya, Chiba (JP)

(21) Appl. No.: 17/153,154

(22) Filed: Jan. 20, 2021

(30) Foreign Application Priority Data
Jan. 22, 2020 (JP) 2020-008603

(51) Int. Cl. G03G 15/09

(52) U.S. Cl. CPC G03G 15/0907; G03G 15/0921

(57) ABSTRACT

A developing device includes a developer container, a rotatable developing member, a magnet, a rotatable magnetic member, a removing member, a first bias applying portion, and a second bias applying portion. An electric field for moving normally charged toner, existing between the rotatable developing member and the rotatable magnetic member, toward the rotatable developing member is generated by applying a first bias to the rotatable developing member by the first bias applying portion and by applying a second bias to the rotatable magnetic member by the second bias applying portion.

### FIELD OF THE INVENTION AND RELATED ART

The present invention relates to a developing device.

In an image forming apparatus of an electrophotographic type, particularly in the image forming apparatus in which a full-color or multi-color image is formed, from a viewpoint of a color (hue) of an image or the like, a two-component developer containing non-magnetic toner and a magnetic carrier as main components is used in many developing devices. In recent years, in such an image forming apparatus, the developing device has been driven at a high speed in order to realize high productivity and a high image forming process speed. Further, toner with a small particle size has been used in order to realize a high image quality. For this reason, a phenomenon that the toner separates from the developer held on a developer carrying member and then scatters or that the toner separates from the developer stirred inside the developing device and then leaks out of the developing device and scatters is liable to occur.

In order to prevent such scattering of the toner, for example, a constitution in which a rotatable member for collecting the scattering toner (hereinafter, referred to as a collecting roller) is provided downstream of the developing device with respect to a rotational direction of a photosensitive drum (image bearing member) and in the neighborhood of the photosensitive drum and the developer carrying member has been known (Japanese Laid-Open Patent Application (JP-A) 2014-115519). In this developing device, the toner scattering is prevented by utilizing a potential difference between a developing bias applied to the developer carrying member and a scattering preventing bias applied to the collecting roller. That is, a voltage on a collecting roller side is made lower than a voltage on a developer carrying member side, whereby negatively charged toner is collected by being moved from the collecting roller to the developer carrying member side. Further, this collecting roller is formed of a non-magnetic and electroconductive material, so that the developer collected between the collecting roller and the developer carrying member is collected by the developer carrying member without being attracted to the collecting roller.

However, in the constitution disclosed in the above-described JP-A 2014-115519, the collecting roller is formed of the non-magnetic material and the voltage on the collecting roller side is made smaller that the voltage on the developer carrying member side, and therefore, the carrier deposits on the collecting roller in some cases. As regards the carrier depositing on the collecting roller, the collecting roller is the non-magnetic material (member), so that there is a high possibility that the carrier drops by rotation of the collecting roller, and in the case where the carrier drops, there is a liability that another member of an image forming portion provided below the collecting roller with respect to a vertical direction is contaminated with the carrier.

### SUMMARY OF THE INVENTION

A principal object of the present invention is to provide a developing device capable of suppressing a drop of a developer from a collecting roller to an outside of the developing device.

According to an aspect of the present invention, there is provided a developing device comprising: a developer container configured to accommodate a developer containing toner and a carrier; a rotatable developing member configured to carry and feed the developer toward a developing position where an electrostatic latent image formed on an image bearing member is developed; a magnet fixedly provided inside the rotatable developing member and configured to generate a magnetic field for carrying the developer on the rotatable developing member; a rotatable magnetic member provided below the developing position with respect to a vertical direction and configured to be magnetized by the magnetic field generated by the magnet; a removing member provided in contact with the rotatable magnetic member and configured to remove the developer from the rotatable magnetic member; a first bias applying portion configured to apply a first bias to the rotatable developing member; and a second bias applying portion configured to apply a second bias to the rotatable magnetic member, wherein an electric field for moving normally charged toner, existing between the rotatable developing member and the rotatable magnetic member, toward the rotatable developing member is generated by applying the first bias to the rotatable developing member by the first bias applying portion and by applying the second bias to the rotatable magnetic member by the second bias applying portion.

Further features of the present invention will become apparent from the following description of exemplary embodiments with reference to the attached drawings.

### BRIEF DESCRIPTION OF THE DRAWINGS

FIG. 1 is a sectional view showing an image forming apparatus in an embodiment.

FIG. 2 is a block diagram of the image forming apparatus in the embodiment.

FIG. 3 is a sectional view of a developing device according to the embodiment.

FIG. 4 is a longitudinal sectional view of the developing device according to the embodiment.

FIG. 5 is an enlarged sectional view of a collecting roller of the developing device according to the embodiment.

FIG. 6 is a graph showing waveforms of a developing bias and a collecting bias in the developing device according to the embodiment.

### DESCRIPTION OF THE EMBODIMENTS

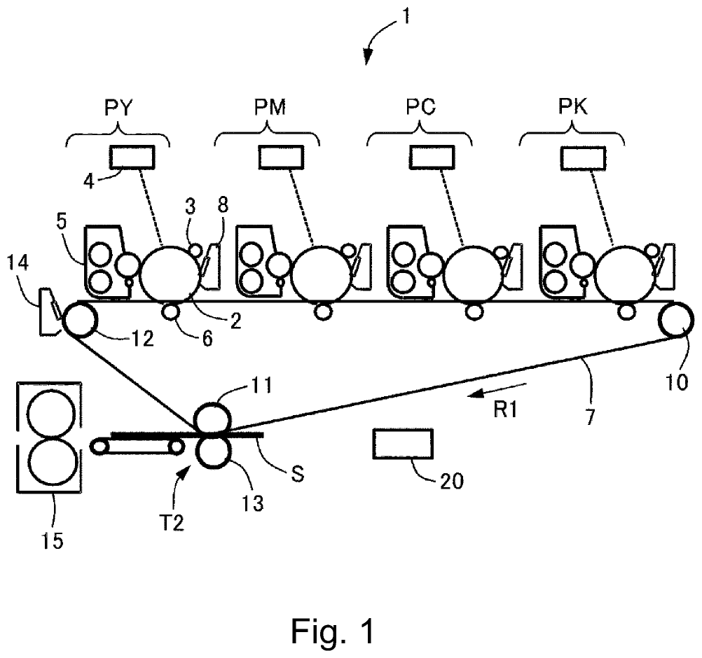

In the following, embodiments of the present invention will be specifically described while making reference to FIGS. 1 to 6. First, a general structure of an image forming apparatus in the embodiments will be described using FIG. 1.

### [Image Forming Apparatus]

An image forming apparatus 1 shown in FIG. 1 is a full-color printer of an electrophotographic type in which image forming portions, PY, PM, PC and PK for four colors (yellow, magenta, cyan and black) are provided in an apparatus main assembly. In this embodiment, the image forming portions PY, PM, PC and PK are of an intermediary transfer tandem type in which these image forming portions are disposed along a rotational direction of an intermediary transfer belt 7 described later. The image forming apparatus 1 forms a toner image on a recording material S in accordance with an image signal from a host device such as a personal computer communicatably connected to an unshown image reading apparatus connected to the apparatus main assembly or communicatably connected to the apparatus main assembly. As the recording material S, it is possible to cite a sheet material such as a sheet, a plastic film, a cloth.

A toner image forming process will be described. First, the image forming portions PY, PM, PC and PK will be described. However, the image forming portions PY, PM, PC and PK are constituted so as to be substantially the same except that colors of toners are yellow, magenta, cyan and black, respectively, different from each other. Therefore, in the following, the image forming portion PY is described as a representative, and other image forming portions PM, PC and PK will be omitted from description.

The image forming portion PY is principally constituted by a photosensitive drum 2, a charging device 3, an exposure device 4, a developing device 5 and the like. A surface of the photosensitive drum 2 as an example of an image bearing member to be rotationally driven is electrically charged uniformly in advance by the charging device 3, and thereafter an electrostatic latent image is formed by the exposure device 4 driven on the basis of a signal of image information. That is, on the photosensitive drum 2, the electrostatic latent image is formed. The electrostatic latent image formed on the photosensitive drum 2 is developed with the toner by the developing device 5, and thus is visualized as the toner image. The toner in the developer to be consumed in the image formation is supplied (replenished) together with a carrier from an unshown toner cartridge.

Thereafter, by a primary transfer roller 6 provided opposed to the photosensitive drum 2 through the intermediary transfer belt 7, a predetermined pressing force and a primary transfer bias are applied, so that the toner image formed on the photosensitive drum 2 is primary-transferred onto the intermediary transfer belt 7. Transfer residual toner slightly remaining on the photosensitive drum 2 is removed by a cleaning device 8, and then the image forming apparatus prepares for a subsequent image forming process.

The intermediary transfer belt 7 is stretched by a tension roller 10, an inner secondary transfer roller 11 and a driving roller 12. The intermediary transfer belt 7 is driven by the driving roller 12 so as to be moved in an arrow R1 direction. Image forming processes for the respective colors processed by the above-described image forming portions PY, PM, PC and PK are carried out at timing when the toner images are successively transferred onto the color toner image primary, transferred on the intermediary transfer belt 7 on an upstream side with respect to a movement direction of the intermediary transfer belt 7. As a result, finally, a full-color toner image is formed on the intermediary transfer belt 7 and is fed t a secondary transfer portion T2. The secondary transfer portion T2 is a transfer nip formed by an outer secondary transfer roller 13 and a portion of the intermediary transfer belt 7 stretched by the inner secondary transfer roller 11. Incidentally, transfer residual toner passed through the secondary transfer portion T2 is removed from the intermediary transfer belt 7 by a transfer cleaner (device) 14.

In parallel to the process of forming the toner image sent to the secondary transfer portion T2, a feeding process of the recording material S to the secondary transfer portion T2 is carried out at similar timing. In the feeding process, the recording material S is fed from an unshown sheet cassette or the like, and is sent toward the secondary transfer portion T2 in synchronism with the image formation timing. At the secondary transfer portion T2, a secondary transfer voltage is applied to the inner secondary transfer roller 11.

As described above, the toner image is secondary-transferred from the intermediary transfer belt 7 onto the recording material S in the secondary transfer portion T2. Thereafter, the recording material S is fed to a fixing device 15 and is heated and pressed by the fixing device 15, so that the toner image is melted and fixed on the recording material S. The recording materials on which the toner image is thus fixed is discharged onto a discharge tray by a discharging roller.

### [Controller]

The image forming apparatus 1 includes a controller 20 for carrying out various pieces of control such as the above-described image forming operation. Operations of the respective portions of the image forming apparatus 1 are controlled by the controller 20 provided in the image forming apparatus 1. A series of the operations of the image forming operation is controlled by the controller 20 in accordance with respective input signals through an operating portion on an upper surface of the apparatus main assembly or through a network.

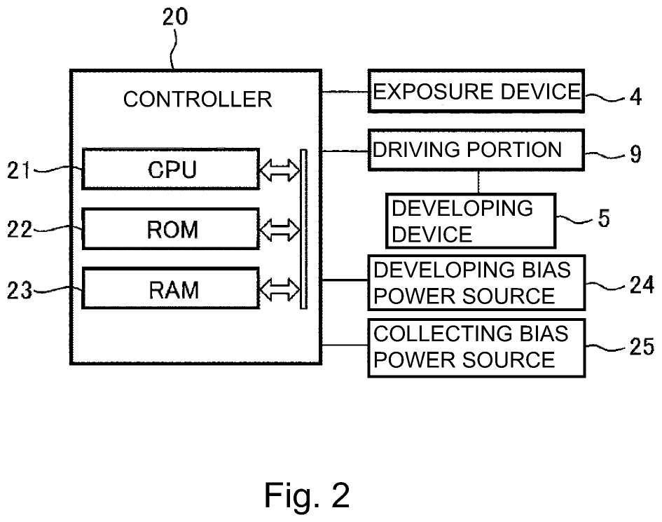

As shown in FIG. 2, the controller 20 includes a CPU (Central Processing Unit) 21 as a calculation control means, a ROM (Read Only Memory) 22, a RAM (Random Access Memory) 23, and the like. The CPU 21 carries out control of the respective portions of the image forming apparatus 1 while reading a program which is stored in the ROM 22 and which corresponds to a control procedure. In the RAM 23, operation data and input data are stored, and on the basis of the above-described program or the like, the CPU 21 carries out the control by making reference to the data stored in the RAM 23. To the controller 20, a driving portion 9 comprising a motor and the like for driving movable members such as the exposure device 4 and screws and a collecting roller 80, which are described later, of the developing device 5, and a developing bias power (voltage) source 24 and a collecting bias power (voltage) source 25 are connected.

### [Two-component Developer]

Next, the developer used in this embodiment will be described. In this embodiment, as the developer, a two-component developer containing non-magnetic toner particles (toner) and magnetic carrier particles (carrier). The toner is colored resin particles containing a binder resin, a colorant and, as desired, other additives, and onto a surface thereof, an external additive such as colloidal silica fine powder is externally added. The toner used in this embodiment is negatively chargeable polyester-based resin material and is about 7.0 μm in volume-average particle size. The carrier used in this embodiment is formed with magnetic metal particles such as surface-oxidized particles of iron, nickel and cobalt, and is about 50 μm in volume-average particle size.

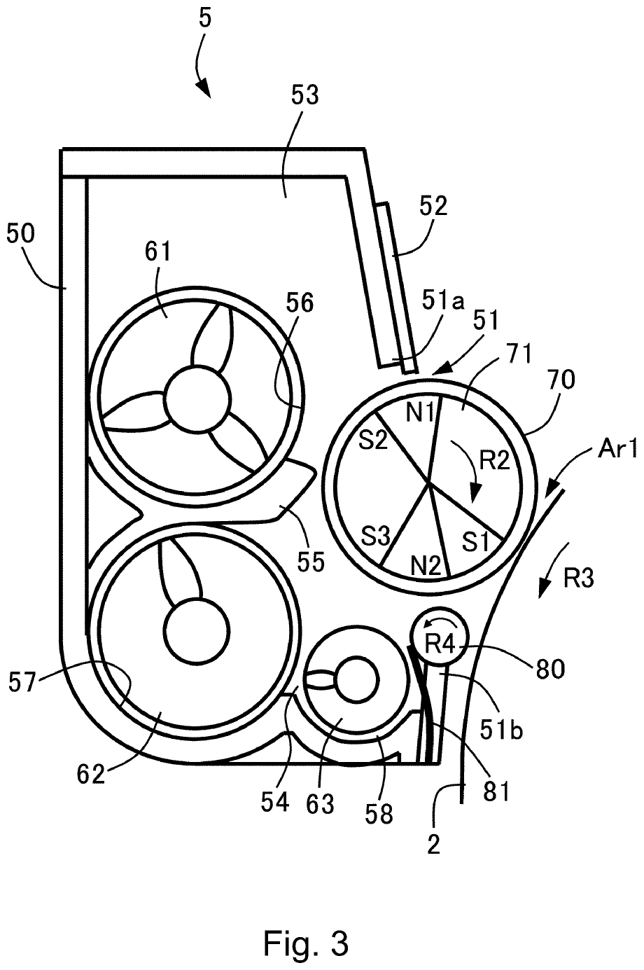

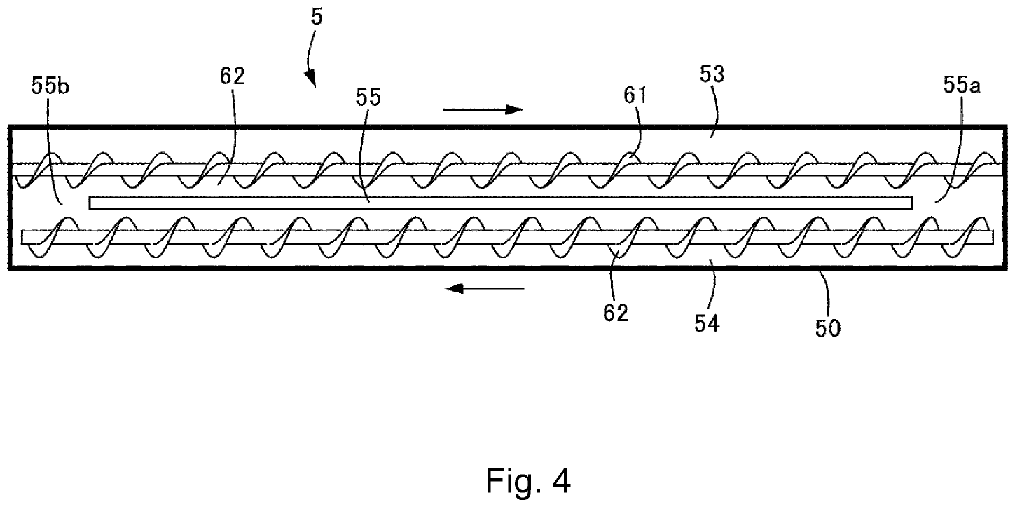

Next, a detailed structure of the developing device 5 will be described using FIGS. 3 and 4. In this embodiment, the developing device 5 is formed in a cartridge shape and constitutes a developing cartridge. FIG. 3 is a cross-sectional view of the developing device 5, and FIG. 4 is a longitudinal sectional view of the developing device 5. The developing device 5 includes a developer container 50 in which the developer is accommodated, a developing sleeve 70 which is an example of a rotatable developing member (developer carrying member), and the collecting roller 80 which is an example of a rotatable member provided below the developing sleeve 70. The developer container 50 is provided with an opening 51 opposing the photosensitive drum 2 and shaft-supports the developing sleeve 70 so as to be rotatable.

The developing sleeve 70 is a cylindrical rotatable member provided at the opening 51, and a part thereof is exposed to an outside of the developer container 50 and carries and feeds the developer toward a developing develop Ar1 where the electrostatic latent image carried on the photosensitive drum 2 is developed with the toner. The developing sleeve 70 rotates while carrying the developer inside the developer container 50, and develops, with the toner, the electrostatic latent image carried on the photosensitive drum 2 in the developing position Ar1. Incidentally, the developing sleeve 70 rotates in an R2 direction, and the photosensitive drum 2 rotates in an R3 direction.

The developing sleeve 70 is constituted by a non-magnetic material, and inside thereof, a magnet roller 71 which is an example of a magnet (magnetic field generating means) is provided by being fixed in a non-rotatable state relative to the developer container 50. The magnet roller 71 has a developing magnetic pole S1, an attracting magnetic pole N1 for attracting the developer, and magnetic poles N2, S2 and S3 (S poles) for feeding the developer. That is, the magnet roller 71 is disposed inside the developing sleeve 70 in a non-rotational state, and has the plurality of magnetic poles arranged in the rotational direction R2 of the developing sleeve 70 and thus generates a magnetic field for carrying the developer on the developing sleeve 70. Of these magnetic poles, the magnetic poles S2 and S3 which has the same polarity are disposed inside the developer container 50 in an adjacent state. By this, a repelling magnetic field for generating a repelling force between the magnetic poles S2 and S3 is formed, so that the developer passed through the developing position Ar1 and remaining on the surface of the developing sleeve 70 can be peeled off from the surface of the developing sleeve 70 in a stirring chamber 54.

The opening 51 of the developer container 50 includes a lower end portion 51b which is one end portion and an upper end portion 51a which is another end portion positioned on a side opposite from the lower end portion 51b. At the upper end portion 51a of the opening 51, a developing blade 52 as an example of a layer thickness regulating member is provided. The developing blade 52 regulates a layer thickness of the developer attracted to and fed by the developing sleeve 70. That is, the developing blade 52 is disposed at the upper end portion 51a of the opening 51 with a predetermined gap between itself and the developing sleeve 70, and regulates the layer thickness of the developer carried on the developing sleeve 70. A free end portion of the developing blade 52 is disposed with the gap of 200 to 1000 μm as the predetermined gap while opposing the developing sleeve 70. In this embodiment, the predetermined gap is set at 400 μm.

The developer container 50 includes a developing chamber 53 as an example of a first chamber and a stirring chamber 54 as an example of a second chamber provided below a rotation center of the developing sleeve 70 with respect to a vertical direction. The developing chamber 53 and the stirring chamber 54 are partitioned by a partition wall 55. That is, the developer container 50 includes the developing chamber 53 for supplying the developer to the developing sleeve 70 and includes the stirring chamber 54 provided below the developing chamber 53 and forming a circulation path of the developer in cooperation with the developing chamber 53.

In a first feeding passage 56 formed in the developing chamber 53, a first screw 61 is provided substantially in parallel to an axis of the developing sleeve 70. In a second feeding passage 57 formed in the stirring chamber 54, a second screw 62 is provided substantially in parallel to the axis of the developing sleeve 70. Further, in a third feeding passage 58 formed in the stirring chamber 54, a third screw 63 is provided substantially in parallel to the axis of the developing sleeve 70. The first screw 61 comprises a multi-thread (multi-start) screw and comprises a three-thread screw. Each of the second screw 62 and the third screw 63 comprises a single-thread screw. However, the number of threads is not limited to the above-described numbers of threads. These screws 61, 62 and 63 are connected to each other through gear trains and are rotated by drive of a driving portion 9 (FIG. 2). At opposite end portions of an inside of the developer container 50, a first communicating portion 55a and a second communicating portion 55b each connecting the developing chamber 53 and the stirring chamber 54 are formed (FIG. 4).

The developer accommodated in the developer container 50 is circulated and fed in arrow directions of FIG. 4 by the first screw 61 and the second screw 62. The developer drops through the first communicating portion 55a by gravitation, and moves from the developing chamber 53 to the stirring chamber 54. Further, the developer is compressed on a downstream side of the second screw 62 with respect to a feeding direction and passes through the second communicating portion 55b, and is scooped in the developing chamber 53. The third screw 63 alleviates compression of the developer by feeding the developer in a direction opposite to the feeding direction of the second screw 62 in order to prevent that the developer compressed by the second screw 62 stagnates at a position where the developer on the developing sleeve 70 is taken in and thus cannot be taken in. The developer is supplied to the developing sleeve 70 while being fed by the first screw 61 and is subjected to a developing process, and thereafter is separated from the developing sleeve 70 in the stirring chamber 54. That is, the stirring chamber 54 collects the developer from the developing sleeve 70, the collecting roller 80 and the scraper 71.

### [Structure of Collecting Roller and Periphery Thereof]

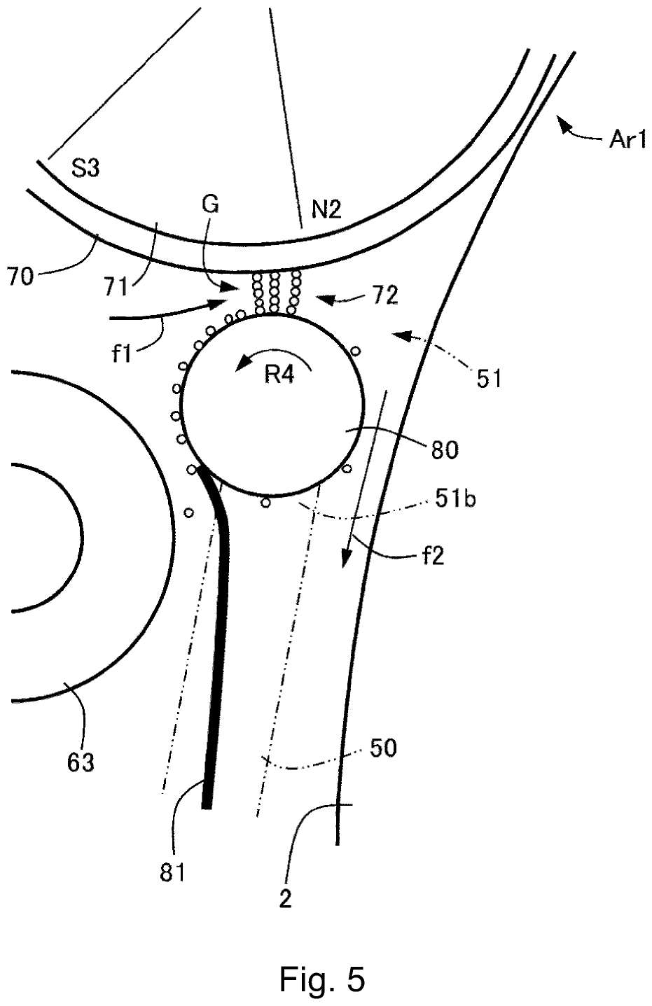

Next, a detailed structure of the collecting roller 80 and a periphery thereof will be described using FIG. 5. The collecting roller 80 is provided at the opening 51 and is disposed below the developing position Ar1 with respect to the vertical direction. In this embodiment, the collecting roller 80 is disposed below the developing sleeve 70 with respect to the vertical direction. The collecting roller 80 comprises a metal shaft of a cylindrical magnetic material, and in this embodiment, a cylindrical iron roller of 5 mm in diameter is used. A gap between the developing sleeve 70 and the collecting roller 80 (minimum distance between the developing sleeve 70 and the collecting roller 80) is 0.5 mm or more and 2.0 mm or less in consideration of a tolerance, and is 1.2 mm in this embodiment. The collecting roller 80 is made of the magnetic material, but is not magnetized. The collecting roller 80 includes a rotation shaft integrated at opposite end portions, and the rotation shaft is supported by the developer container 50 so as to be rotatable. The rotational shaft is drive-connected to the driving portion 9 (FIG. 2) through an unshown gear train and is connected to a collecting bias power (voltage) source 25 (FIG. 2). The collecting roller 80 is rotated in an arrow R3 direction by the drive of the driving portion 9 (FIG. 2).

The collecting roller 80 is provided between the developing sleeve 70 and the lower end portion 51b, which is one end portion of the opening 51, opposing the developing sleeve 70. By this, it is possible to suppress that the toner flying inside the developer container 50 scatters from the neighborhood of the lower end portion 51b of the opening 51 to an outside.

On the surface of the collecting roller 80, the sheet-like scraper 81 as an example of a cleaning means is provided in contact with the collecting roller surface. The scraper 81 is formed by a PET sheet or a sheet obtained by subjecting the PET sheet to antistatic finish. The scraper 81 is fixed at a base end portion thereof to the developer container 50 by a fixing means such as a double-side tape or an adhesive, and a free end portion thereof is contacted to the collecting roller 80 toward a direction opposite to the rotational direction R3 of the collecting roller 80. The scraper 81 is provided inside the developer container 50 and peels off the developer on the surface of the collecting roller 80 by scraping off the developer by a free end thereof and thus cleans the surface of the collecting roller 80.

In order to clean the collecting roller surface by scraping off the developer depositing on the collecting roller surface, the scraper 81 is contacted to the collecting roller 80. In order to scrap off the developer in a large amount, there is a need to make a contact force between the scraper 81 and the collecting roller 80 larger, but rigidity capable of withstanding the contact force is required for the collecting roller 80, and therefore, an outer diameter has to be made large, so that the developing device 5 is upsized. In order to downsize the developing device 5, the collecting roller 80 has to be downsized, and when the contact force of the scraper 81 cannot be sufficiently ensured, the developer is liable to easily pass through the scraper 81. Further, even when a necessary contact force was capable of being ensured, if a particle size of the toner becomes small, the toner is liable to easily pass through the scraper 81, and therefore, a scraping-off effect can only be achieved to a certain degree. Thus, the developer passed through the scraper 81 drops and deposits on the intermediary transfer belt 7 and the photosensitive drum 2, so that there is a liability of an occurrence of an image defect.

Therefore, in this embodiment, not only the collecting roller 80 is formed by the magnetic material, but also the collecting roller 80 is disposed in the neighborhood of the magnet roller 71. The collecting roller 80 is disposed substantially just below the magnetic pole N2 of the magnet roller 71. A peak value of magnetic flex density of the magnetic pole N2 of the magnet roller 71 is 500 gauss, and a half-width is set at 30°. By this, the collecting roller 80 is magnetized by magnetic lines of force from the magnetic pole N2, so that the collecting roller 80 can rotate while attracting the magnetic carrier. Even when the carrier passed through the scraper 81, the magnet roller 71 is capable of holding the carrier so as not to drop from the collecting roller 80. That is, the collecting roller 80 is disposed within a range in which predetermined magnetic flux density at which the collecting roller 80 is magnetized to the extent such that the carrier can be attracted can be obtained. By preventing the carrier from dropping from the collecting roller 80, different from the conventional constitution, it is possible to suppress that the carrier dropped from the collecting roller 80 drops on, for example, the intermediary transfer belt 7 and generates a spot-like image defect.

Further, in a gap G between the developing sleeve 70 and the collecting roller 80, the magnetic lines of force generates around the magnetic pole N2, and the carrier forms a magnetic chain (brush) 72 along the magnetic lines of force. For this reason, floating toner in the developer container 50, likely to pass through the gap G is collected by the magnetic chain 72, so that scattering of the toner to the outside of the developer container 50 is suppressed.

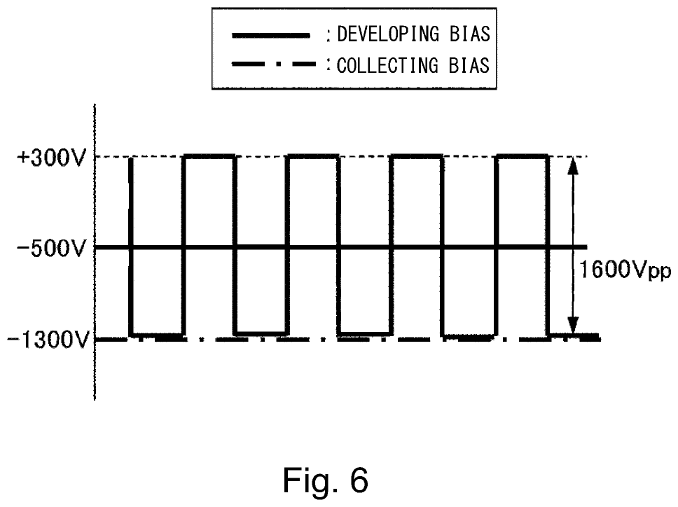

Next, application of biases to the developing sleeve 70 and the collecting roller 80 will be described using FIGS. 5 and 6. In this embodiment, the developer is the two-component developer, and the carrier and the toner electrostatically attract each other. In this embodiment, the carrier is positively charged, and the toner is negatively charged.

To the developing sleeve 70, a developing bias is applied by the developing bias power source 24 (FIG. 2). As shown in FIG. 6, in this embodiment, as the developing bias, a DC voltage of −500 V and an AC voltage (peak-to-peak) voltage Vpp of 1600 V are applied in a superposed form.

On the other hand, to the collecting roller 80, a collecting bias is applied by the collecting bias power source 25 (FIG. 2) as an example of a bias applying device capable of applying the collecting bias to the collecting roller 80. As shown in FIG. 6, in this embodiment, the polarity of the collecting bias is the same as the polarity of the normally charged toner relative to the developing sleeve 70, and as the collecting bias, a DC voltage of −1300 V is applied. The collecting bias power source 25 applies the collecting bias to the collecting roller 80, whereby an electric field causing a force from the collecting roller 80 toward the developing sleeve 70 to act on the normally charged toner which is negatively charged and which is positioned in the gap G between the collecting roller 80 and the developing sleeve 70 is formed. Incidentally, in this embodiment, the normally charged toner having the same polarity as the collecting bias means the negatively charged toner and does not include reversely charged toner which is positively charged.

Motion of the developer in the neighborhood of the above-described collecting roller 80 will be described using FIG. 5. In this embodiment, to the collecting roller 80, the collecting bias which is negative relative to the developing bias applied to the developing sleeve 70 is applied. For this reason, the toner floating inside the developer container 50 is likely to scatter from the inside of the developer container 50 along a path f1 through the gap G between the collecting roller 80 and the developing sleeve 70. This toner receives a force from the electric field in a direction from the collecting roller 80 toward the developing sleeve 70 in the gap G and in the neighborhood thereof, and is collected by the developing sleeve 70. Further, in the gap G, the magnetic chain 72 is formed, so that the toner is also easily collected by the magnetic chain 72, and the toner collected by the magnetic chain 72 is collected by the developing sleeve 70 by an electric field force.

On the other hand, the collecting roller 80 which is the magnetic material is magnetized, and therefore, the magnetic carrier is collected by the collecting roller 80. Most of the carrier attracted to the surface of the collecting roller 80 is removed by the scraper 81 with rotation of the collecting roller 80, but a part of the carrier passes through the scraper 81. This carrier passed through the scraper 81 is moved by rotation of the collecting roller 80 without dropping from the collecting roller 80 while being attracted to the collecting roller 80. Then, the carrier openings again the scraper 81 after rotation of the collecting roller 80 through one-full circumference, and is scraped off by the scraper 81 or passes through the scraper 81. Thus, the carrier attracted to the collecting roller 80 is still attracted to the collecting roller 80 until the carrier is scraped off by the scraper 81.

For this reason, different from the case where the collecting roller of the non-magnetic material is used, it is possible to suppress that the carrier passed through the scraper drops on the intermediary transfer belt or the like and causes a lowering in image quality. That is, by magnetizing the collecting roller 80, it is possible to suppress in conveniences caused by the developer passed through the scraper 81.

Further, the toner scattered in the developing position Ar1 where the developing sleeve 70 and the photosensitive drum 2 are closest to each other is likely to scatter along a path f2, but the toner deposits on the photosensitive drum 2 by receiving repelling force from the collecting bias applied to the collecting roller 80, and thereafter is transferred onto the intermediary transfer belt 7. For this reason, the scattering of the toner scattered in the developing position Ar1 is also suppressed, so that it is possible to alleviate that the toner drops outside the developer container 50 and causes a spot-like image defect.

As described above, in the developing device 5 of this embodiment, the collecting roller 80 is formed of the magnetic material, and therefore the magnetic carrier is attracted to the collecting roller 80, so that even when a part of the carrier passes through the scraper 81, it is possible to suppress the drop thereof from the collecting roller 80. For this reason, different from the case where the collecting roller of the non-magnetic material is used, it is possible to suppress that the carrier passed through the scraper 81 drops and leaks out of the developer container 50. Further, the magnetic chain 72 is formed in the gap G between the collecting roller 80 and the developing sleeve 70, so that it is effectively collect the floating toner which is likely to pass through the gap G and to leak out of the developer container 50. Accordingly, it is possible to suppress that the developer leaks out of the developer container 50.

Further, according to the developing device 5 of this embodiment, the scraper 81 is utilized as the cleaning means, so that the collecting roller 80 can be effectively cleaned with a simple and inexpensive constitution.

Incidentally, in the above-described developing device 5 of this embodiment, the case where as the cleaning means for the collecting roller 80, the means for scraping off the developer by the scraper 81 was described, but the present invention is not limited. For example, a means for electrostatically peeling off the carrier may also be applied to the present invention. Or, the cleaning means such as the scraper 81 may also be not provided.

Further, in the developing device 5 of this embodiment, the case where the cylinder made of the iron was used as the collecting roller 80 was described, but the present invention is not limited thereto. As the collecting roller 80, a solid member may also be used, and a material thereof, a ferromagnetic material such as nickel or cobalt may also be used.

Further, in the developing device 5 of this embodiment, the case where the collecting roller 80 is disposed substantially below the magnetic pole N2 of the magnet roller 71 was described, but the present invention is not limited thereto. When the collecting roller 80 is capable of obtaining predetermined magnetic flux density such that the collecting roller 80 is magnetized to the extent that the collecting roller 80 can attract the carrier, for example, the collecting roller 80 may be disposed in a position away from the magnetic pole N2 or may also be disposed in the neighborhood of another magnetic pole.

Further, in the developing device 5 of this embodiment, the case where the normally charged toner is the negatively charged toner and therefore the collecting bias is the negative DC voltage relative to the developing bias was described, but the present invention is not limited thereto. For example, in the case where the normally charged toner is the positively charged toner, the collecting bias can be the positive DC voltage relative to the developing bias. Also, in this embodiment, the collecting roller 80 is formed of the magnetic material, so that the magnetic carrier is attracted thereto and even when a part of the carrier passes through the scraper 81, it is possible to suppress the drop of the carrier from the collecting roller 80.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-008603 filed on Jan. 22, 2020, which is hereby incorporated by reference herein in its entirety.

What is claimed is:

1. A developing device comprising:
a developer container configured to accommodate a developer containing toner and a carrier;
a rotatable developing member configured to carry and feed the developer toward a developing position where an electrostatic latent image formed on an image bearing member is developed;
a magnet fixedly provided inside said rotatable developing member and configured to generate a magnetic field for carrying the developer on said rotatable developing member;
a rotatable magnetic member provided below the developing position with respect to a vertical direction and configured to be magnetized by the magnetic field generated by said magnet;
a removing member provided in contact with said rotatable magnetic member and configured to remove the developer from said rotatable magnetic member;
a first bias applying portion configured to apply a first bias to said rotatable developing member; and
a second bias applying portion configured to apply a second bias to said rotatable magnetic member,
wherein an electric field for moving normally charged toner, existing between said rotatable developing member and said rotatable magnetic member, toward said rotatable developing member is generated by applying the first bias to said rotatable developing member by said first bias applying portion and by applying the second bias to said rotatable magnetic member by said second bias applying portion.

2. A developing device according to claim 1, wherein said rotatable magnetic member is provided below said rotatable developing member with respect to the vertical direction.

3. A developing device according to claim 1, wherein a minimum distance between said rotatable developing member and said rotatable magnetic member is 0.5 mm or more and 2.0 mm or less.

4. A developing device according to claim 1, wherein the normally charged toner is negatively charged toner.
